(19) United States
(12) Patent Application Publication
(10) Pub. No.: US 2003/0137689 A1
(43) Pub. Date: Jul. 24, 2003

(54) Remote printer driver server

(75) Inventor: Raymond C. Bontempi, Jamison, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: General Instrument Corporation.

(21) Appl. No.: 10/052,590

(22) Filed: Jan. 18, 2002

(51) Int. Cl. G06F 3/12; G06F 13/10

(52) U.S. Cl. 358/1.15; 709/321; 710/8

(57) ABSTRACT

A system for printing application data comprising a client originating the application data and a printer driver server, remotely connected to the client, which receives the application data. The printer driver server includes a database containing a plurality of printer drivers and a transcoder. The transcoder transcodes the format of the received application data to a printer format using one of the printer drivers retrieved from the database and transmits the application data in the printer format to a printer.

### BACKGROUND OF THE INVENTION

1. Field of the Invention

The present invention relates to computer systems for printing documents and more particularly to a system and method for printing a document using a printer driver which is stored in a database remote from a requesting computer.

2. Background Information

In order to print a document which has been created on a computer device, the computer device must utilize a computer program to convert (i.e., transcode) the structure (i.e., format) of the document data to a format compatible with the printer on which the document is to be printed. However, no single format applies to all printers. Typically, each manufacturer requires a unique character set for controlling printer functions such as line feeds, carriage returns, font selection etc. Further, even for a single manufacturer, the format of the document data required for printing may vary from one model of a printer to another, depending on the enhancements of the printer. Further, the required format of the document data may vary with the mode of the printer, i.e., graphic, character etc.

To further complicate document printing, there is no single standard for storing the data output of the various applications that create printable documents. Thus, popular word processors such as Microsoft Word® (doc file format), Acrobat® (pdf file format) and Wordperfect® (wp file format) store documents using different formats. In addition to the aforementioned popular word processors, there are numerous other applications that use unique formats for storing their outputs, as well as defacto standard document formats, such as “txt,” “rtf,” etc. In addition to the differing printer formats and document formats, there are a plurality of print job control protocols such as Hewlett Packard's printer command language (PCL) and Adobe Systems Postscript® (a page description language).

The aggregation of the above multiplicity of format conversions which make printing possible on a printer is typically incorporated into a computer program referred to as a printer driver. Each printer driver is unique to a particular printer type or family of printers. Since each printer driver must accommodate a wide variety of document formats, printer drivers tend to be large. Typically each printer driver requires four megabytes or more of computer memory.

Typically, computers that include a hard drive, or that have having access to large capacity memory such as might be present on a computer network, have little difficulty gaining access to one or more printer drivers, thereby allowing applications which execute on the computer to utilize a variety of different printers for printing. However, many devices which are in use today, such as hand-held devices, settop boxes and webpad devices, do not include a hard disk and do not have access to other non-volatile mass storage suitable for storing printer drivers. Accordingly, it would be desirable for devices which have a limited amount of non-volatile memory to have access to a device which stores a variety of printer drivers. In this manner, documents may be printed on a variety of printers which are dedicated to the device or accessible to a number of devices.

### BRIEF SUMMARY OF THE INVENTION

Briefly stated the present invention comprises a system for printing application data wherein a client originates the application data, and a printer driver server, remotely connected to the client, receives the application data. The printer driver server includes a database containing a plurality of printer drivers and a transcoder, wherein the transcoder transcodes a format of the received application data to a printer format using one of the plurality of printer drivers retrieved from the database and transmits the application data in the printer format to a printer.

The present invention further includes a method for printing application data comprising the steps of forming a connection between a client and a server; transmitting the application data from the client to the server; transcoding a format of the application data to a printer format; transmitting the application data in the printer format to a printer; and printing the data.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a functional block diagram of a system for printing application data according to a preferred embodiment;

FIG. 2 is a flow diagram of the steps for printing the application data in accordance with the preferred embodiment;

FIG. 3a is a diagram of a data format for transmitting the application data between a client and a printer driver server or between a printer driver server and a printer;

FIG. 3b is a diagram of the data format used for transmitting the application data to the printer via the client; and

FIG. 3c is a diagram of the data format used for transmitting the application data directly to the printer.

### DETAILED DESCRIPTION OF THE INVENTION

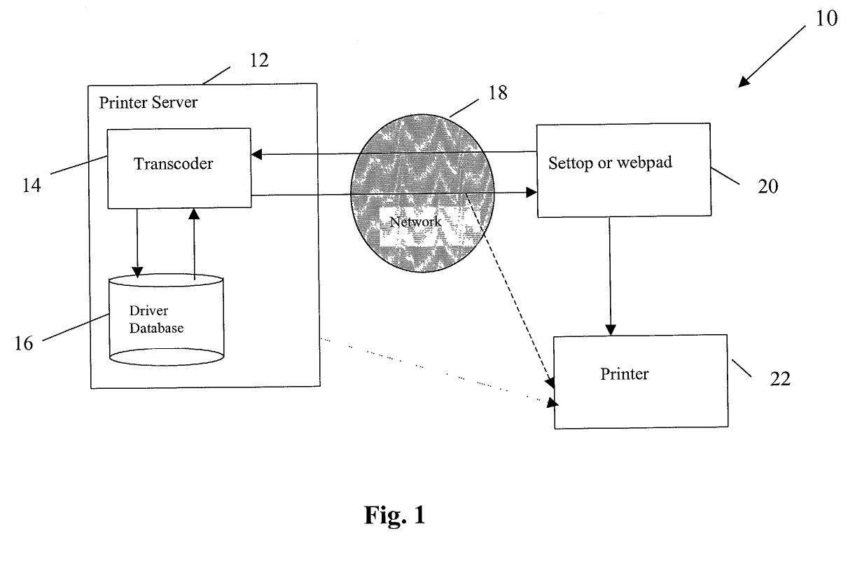

FIG. 1 shows a functional block diagram of a preferred embodiment of a system 10 for printing application data, comprising a client device 20 which originates the application data, and a printer driver server 12 remote from the client device 20 for receiving the application data in an application format, transcoding the application data from the application format to a printer format, and transmitting the transcoded application data to a printer 22.

Preferably, the client device 20 and the printer driver server 12 are connected to an Internet protocol (IP) network 18. The network 18 may be private network such as a local area network (LAN), a private wide area network (WAN), or a public WAN such as the well known Internet. Preferably, the client device 20 is connected to the network 18 via a known broadband cable system in which the communication media between the client device 20 and the network 18 is shared. Alternatively, the client device 20 could be connected to the network 18 via a local area network or via a dedicated communications circuit, either wireless or wired.

Preferably, the client device 20 is a settop box, i.e., a home device that sits atop a television set of a subscriber of the broadband cable system (not shown) and allows the subscriber to receive and transmit information via the broadband cable system, including receiving analog and digital cable television and browsing the World Wide Web. One example of such a settop box is the DCT 5000, manufactured by Motorola, Inc., having; a cable modem, an MPEG decoder, a programmable computer including sufficient memory to execute special versions of Web browsers and other application software; and an input/output controller for accepting user commands from a keyboard or other user input device, and for outputting data to a display and/or to a printer 22. The scope of the present invention includes other settop boxes manufactured by other companies having similar characteristics as the DCT 5000. Further, the client device 20 is not limited to settop boxes. Other devices which tend to have little non-volatile memory such as an EVR™, manufactured by Motorola, Inc., may also benefit from being configured as the client device 20. While the present invention is particularly advantageous for those types of devices which lack a large capacity non-volatile memory, such as provided by a hard disk, the client device 20 could be any type of computer having a communication port which provides connectivity to the printer driver server 12.

In the preferred embodiment, the printer driver server 12 is a conventional computer having a CPU, memory and input/output capabilities. Preferably, the memory includes a hard disk or comparable device having a large non-volatile storage capacity and rapid access to files stored thereon. The printer driver server 12 also includes a database 16 which resides in the memory and contains a plurality of printer drivers, each of which may be retrieved from the database 16 based on a printer identifier.

The printer driver server 12 also includes transcoder computer program 14. The transcoder computer program 14 executes in the CPU and the memory to: (1) receive application data in an application format from the client device 20, (2) transcode the application data in the application format to a printer format compatible with the printer 22 to be used for printing the application data, and (3) transmit the application data in the printer format to the printer 22.

In the preferred embodiment, the printer 22 is dedicated to the use of client device 20 and receives the application data in the printer format directly from the client device 20. Preferably, the printer 22 is directly connected to the client device 20 via a wireless connection which supports IEEE 802.11 protocol. However, the printer 22 could also be connected to the client device 20 by one of a number of other well known parallel, serial or local area network (LAN) wired means. Alternatively, the printer 22 could receive the application data in the printer format directly from the printer driver server 12 by the printer 22 being directly attached to the printer driver server 12 or via the network 18.

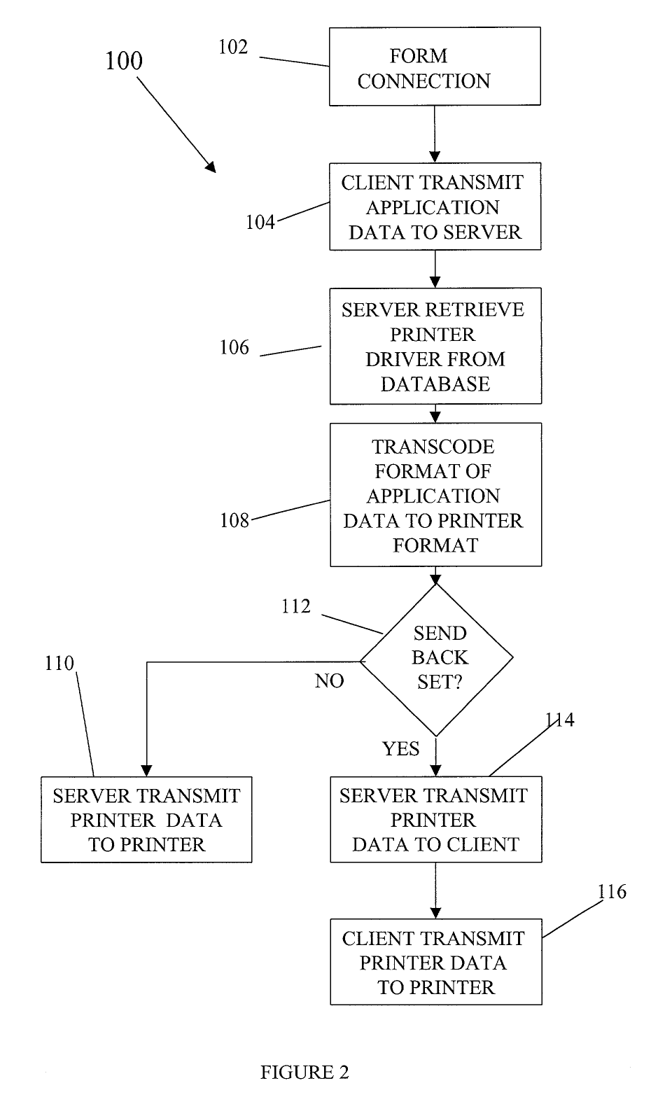

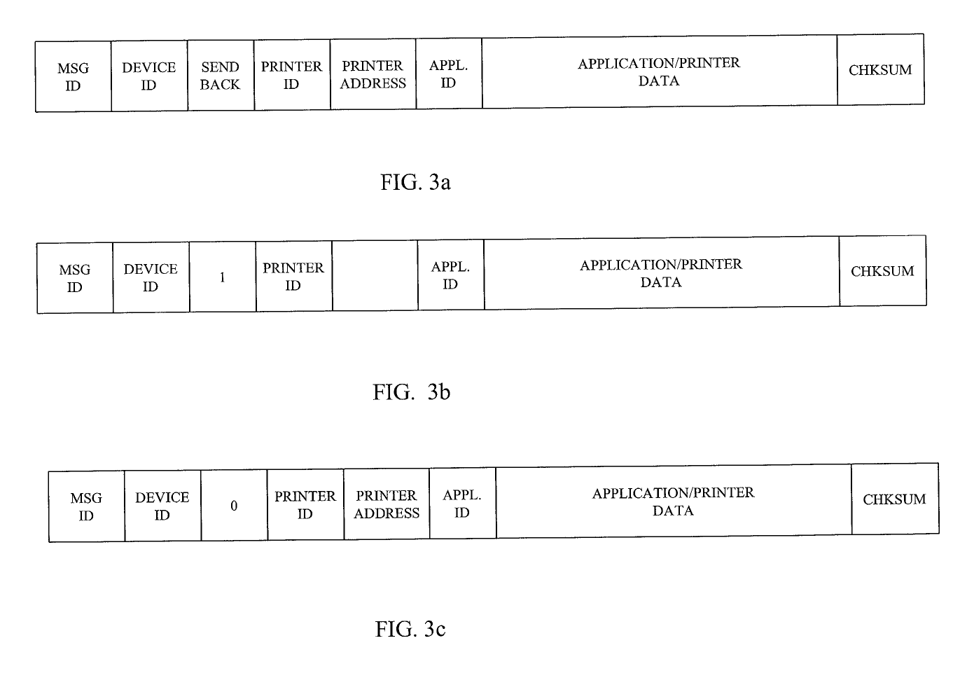

FIG. 2 shows a preferred process 100 for printing application data using the printer driver server 12 to transcode the format of the application data received from the client device 20 in an application format to a printer format compatible with the printer 22. First, a connection is formed between the client device 20 and the printer driver server 12 (step 102). The forming of the connection allows application data to flow between the client device 20 and the printer driver server 12. Next, the application data is transmitted from the client device 20 to the printer driver server 12 (step 104). Preferably, the application data to and from the printer driver server 12 is embedded in a formatted data message, shown generally in FIG. 3a. The data message comprises fields containing the following data with data messages:

(1) a unique message identification serial number for correlating the data messages outgoing from the client device 20 with the data messages incoming to the client device 20;

(2) a device identification character string which is assigned to each client device 20 when the client device 20 is initialized;

(3) a “send back” flag which, when set, indicates to the printer driver server 12 that the application data transmitted to the printer driver server 12 by the client device 20 is to be returned to the client device 20 after the printer driver server 12 transcodes the received application data to a printer format, and, when not set, indicates to the printer driver server 12 that the transcoded data is to be transmitted to the printer 22 identified in a printer identification field of the message at an address identified in a printer address field of the message;

(4) a printer identification character string identifying the type of the printer 22 on which the transcoded is to be printed;

(5) the address of the printer 22 on which the transcoded data is to be printed;

(6) an application identification character string identifying the format of the data in the application/printer data field;

(7) a character string comprising the application data in either the application format or the printer format; and

(8) a checksum for error control.

FIG. 3b shows the format of the message used for application data which is to be returned to the client device 20 for printing on the printer 22. FIG. 3c is the format of the message used for application data to be transmitted directly from the printer driver server 12 to the printer 22.

Referring again to FIG. 2, upon receipt of the application data by the printer driver server 12, the printer driver server 12 examines the printer identification field and the application identification field to select the printer driver required to transcode the application data to form the printer data. The printer driver server 12 then retrieves the selected printer driver required for transcoding the application data (step 106) from the driver database 16 and transcodes the application data to the format required by the selected printer 22 (step 108). The printer driver server 12 then examines the “send back” field (step 112) to determine if the printer data is to be transmitted to the printer 22 which is dedicated to the client device 20 (steps 114 and 116) or transmitted directly to the printer 22 using the printer address in the printer address field (step 110). Alternatively, where the printer 22 is connected to the printer driver server 22 either directly or via the network 18, the required printer driver may be selected by examining the address of the printer 22 and utilizing information stored in the database of the printer driver server 12 that relates the address of the printer to the type of printer located at the address.

In summary, the present invention provides a system and method for enabling a device having a limited amount of non-volatile memory to print application data produced by a variety of applications resident in the device to a variety of printers by storing a plurality of printer drivers in a remote printer driver server accessible to the device.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method for printing application data comprising the steps of:
forming a connection between a client and a printer driver server;
transmitting the application data from the client to the printer driver server;
transcoding a format of the application data received in the printer driver server to a printer format;
transmitting the transcoded application data in the printer format from the printer driver server to a printer; and
printing the data.

2. The method according to claim 1, further including the step of transmitting a printer identifier from the client to the server, wherein the printer identifier identifies the type of printer on which the application data is to be printed.

3. The method according to claim 2, further including the step of retrieving a printer driver from a database, the retrieved printer driver being based on the printer identifier.

4. The method according to claim 1, wherein the application data in the printer format is transmitted to the client for subsequent printing on the printer.

5. The method according to claim 1, further including the step of transmitting an address of the printer from the client to the server, wherein the application data in the printer format is transmitted directly to the printer using the address of the printer.

6. A system for printing application data comprising:
a client originating the application data; and
a printer driver server remotely connected to the client, which receives the application data, the printer driver server including a database containing a plurality of printer drivers and a transcoder configured to: (a) convert a format of the received application data to a printer format using one of the plurality of printer drivers retrieved from the database and (b) transmit the application data in the printer format to a printer.

7. The system according to claim 6, wherein the printer receives the application data in the printer format via the client.

8. The system according to claim 6, wherein the printer receives the application data in the printer format directly from the printer server.

9. A printer driver server remotely connected to a client comprising:
a database containing a plurality of printer drivers, and
a transcoder, wherein the transcoder is configured to convert a format of application data received from the client to a printer format using a selected one of the plurality of printer drivers retrieved from the database.

10. The server according to claim 9, wherein the printer driver server selects the printer driver based on a command received from the client.

11. The server according to claim 10, wherein the command includes an identification of the printer.

12. The server according to claim 10, wherein the command includes an address of the printer and the printer driver server determines an identification of the printer based on the address of the printer and information in the printer driver server database relating the address of the printer to the identification of the printer.
